(19) United States
(12) Patent Application Publication
(10) Pub. No.: US 2008/0146076 A1
(43) Pub. Date: Jun. 19, 2008

(54) All-in-one connecting base having waterproof device

(76) Inventors: Hsiao-Ho Tan, Sindian City (TW); Wen-Lu Liao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/640,270

(22) Filed: Dec. 18, 2006

(51) Int. Cl. H01R 13/52

(52) U.S. Cl. 439/519

(57) ABSTRACT

An all-in-one connecting base having a waterproof device includes a connecting base body, a waterproof shell and a waterproof device. At least one connecting port is set on the connecting base body. The waterproof shell is mounted outside of the connecting base body and covers the connecting ports. The waterproof device is set movably on the waterproof shell. Thereby, the all-in-one connecting base having a waterproof device is assembled. It is convenient to assemble or dismantle the waterproof shell to shorten maintenance and assembly times. Moreover, it is unnecessary to design a new waterproof loop for the different types of the connecting ports, which reduces purchasing costs and avoid costly purchasing of accessories, in order to reduce overall costs.

### BACKGROUND OF THE INVENTION

1. Field of the Invention

The present invention relates to an all-in-one connecting base having a waterproof device, and more specifically to a device covering a plurality of connecting ports that protects the contents from water and dust.

2. Description of the Prior Art

A waterproof connector is disclosed in TW patent 539279 (published on Jun. 21, 2003), the waterproof connector includes a first connecting end, which includes a first connecting port and a first waterproof loop circling the first connecting port, and a second connecting end, which includes a second connecting port and a second waterproof loop circling the second connecting port. When the first connecting end is connected to the second connecting end, the first connecting port is connected electronically with the second connecting port, and the first waterproof loop is firmly joined with the second waterproof loop.

For the waterproof device, the waterproof loops are set around the connecting port. The waterproof loops are joined firmly to protect against water. However, the figure of the waterproof loops may be changed to adapt to multiple types of connecting ports. As such, the cost of the module is increased. Furthermore, it is inconvenient to assemble and maintain the waterproof device because there are several connecting ports to be joined and dismantled.

Hence, the inventors of the present invention believe that these shortcomings above are able to be improved upon and suggest the present invention which is of a reasonable design and is an effective improvement based on deep research and thought.

### SUMMARY OF THE INVENTION

An object of the present invention is to provide an all-in-one connecting base having a waterproof device. It is convenient to assemble or dismantle the waterproof shell to shorten the time spent maintaining and assembling the device. Moreover, it is unnecessary to design a new waterproof loop for the different types of the connecting ports or to purchase costly accessories, which reduces purchasing costs.

To achieve the above-mentioned object, an all-in-one connecting base having a waterproof device is disclosed. The device includes a connecting base body, at least one connecting port is set thereon. A waterproof shell is mounted outside the connecting base body and covers the connecting ports, and a waterproof device is set movably on the waterproof shell.

To further understand the features and technical contents of the present invention, please refer to the following detailed description and drawings related to the present invention. However, the drawings are only to be used as references and explanations, and not to limit the present invention.

### BRIEF DESCRIPTION OF THE DRAWINGS

FIG. 1 is an explored isometric view of a first embodiment of an all-in-one connecting base having a waterproof device of the present invention;

FIG. 2 is an isometric view of a first embodiment of an all-in-one connecting base having a waterproof device of the present invention;

FIG. 3 is an isometric view in another angle of a first embodiment of an all-in-one connecting base having a waterproof device of the present invention;

FIG. 4 is view of an all-in-one connecting base having a waterproof device in use of the present invention;

FIG. 5 is an explored isometric view of a second embodiment of an all-in-one connecting base having a waterproof device of the present invention; and

FIG. 6 is an explored isometric view of a third embodiment of an all-in-one connecting base having a waterproof device of the present invention.

### DETAILED DESCRIPTION OF THE INVENTION

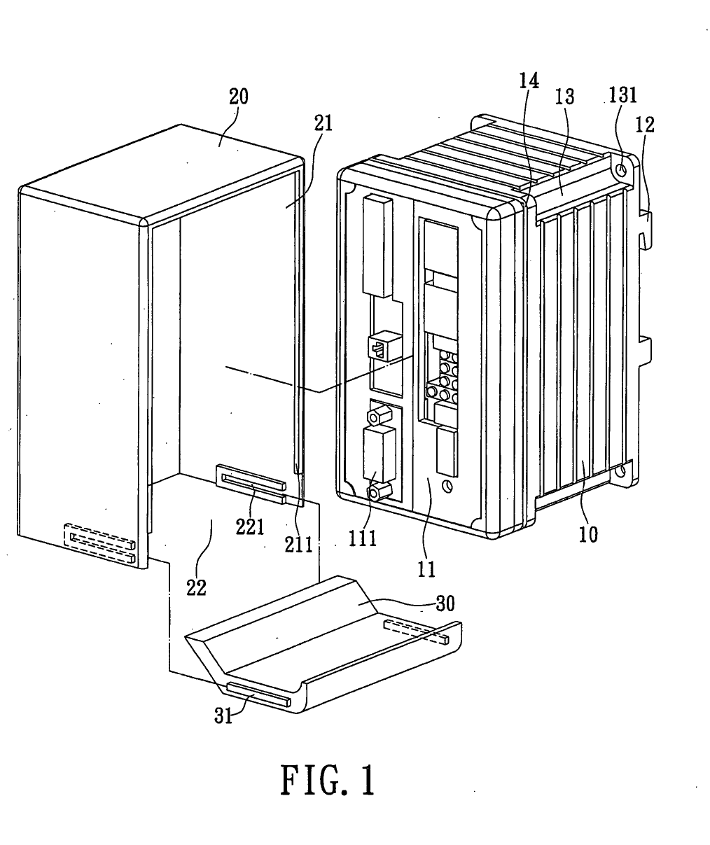

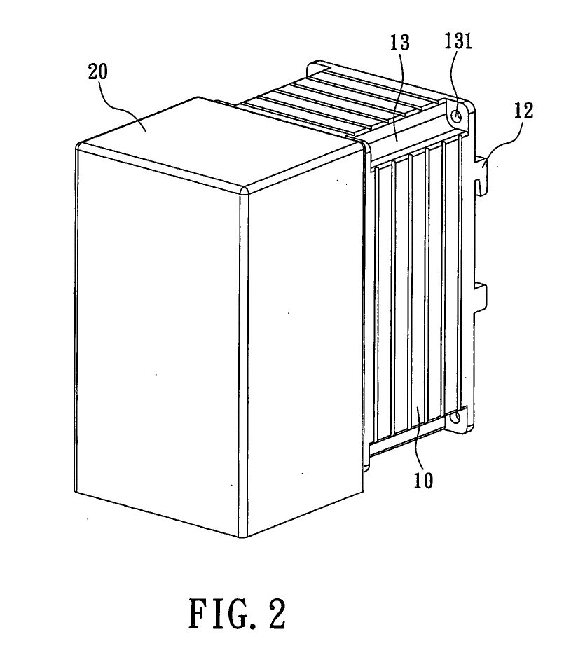

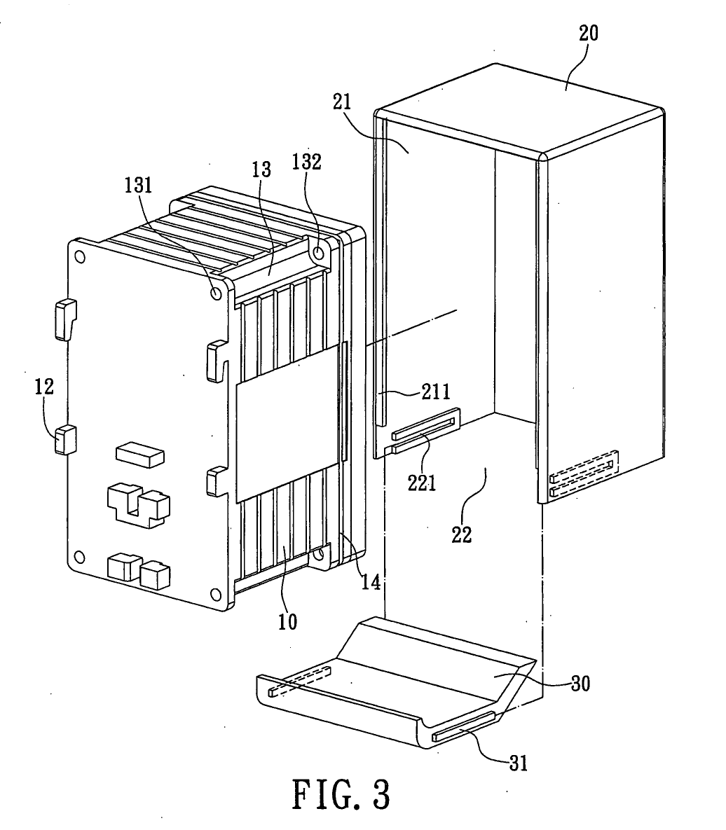

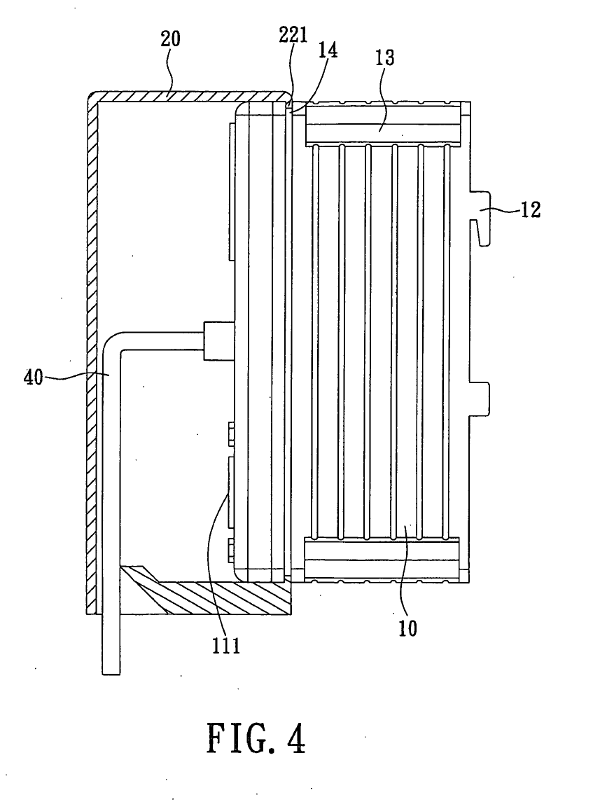

Referring to FIGS. 1-4, an all-in-one connecting base having a waterproof of the present invention is shown. The connecting base includes a connecting base body 10, a waterproof shell 20, and a waterproof device 30.

The connecting base body 10 is cube-shaped, a connecting port board 11 is defined on the front surface of the connecting base body 10, and a plurality of connecting ports 111 are set on the connecting port board 11. The connecting port 111 can be a power connecting port, a voice connecting port, a display screen connecting port, a serial connecting port, or a network connecting port, and so on. A fixing portion 12 is set on the outside surface of the connecting base body 10 and the connecting base body can be disposed on a fixity such as a outdoor wall (not shown) via fixing the fixing portion 12. Four corners of the connecting base body 10 are sunken to form integrating portions 13. the integrating portion 13 has a through hole 131 on a rear side, and a screw hole 132 on the front side thereof to connect base body 10 fixed on a fixity (not shown) by fastening a bolt into the screw hole 132 after the bolt passes the through hole 131. A lock slot 14 is defined circularly on the outside of the connecting base body 10 near the connecting port board 11. The waterproof shell 20 is mated with the lock slot 14.

The waterproof shell 20 is a hollow case and has a hatch 21 and an integrating hatch 22 thereof. The hatch 21 is defined on the back wall of the waterproof shell 20. A lock block 211 is set inside the waterproof shell 20 at the hatch 21 to mate with the lock slot 14 of the connecting base body 10, thereby allowing the waterproof shell 20 mounted out of the connecting base body 10 to cover the connecting ports 111. The integrating hatch 22 is defined on the bottom of the waterproof shell 20. The waterproof shell 20 has two integrating slots 221 on two opposite sides inside the integrating hatch 22, and the waterproof device 30 is locked by the integrating slots 221.

The waterproof device 30 is a cover and two integrating flanges 31 are set on two opposite outside walls of the waterproof device to mate with the two integrating slots 221 on the waterproof shell 20 respectively. Thereby the waterproof device 30 is connected movably with the waterproof shell 20 allowing to provide an all-in-one connecting base have waterproofing device in this invention.

When in use, a transmission wire 40 and the connecting ports 111 of the connecting base body 10 are firstly connected. The waterproof shell 20 is pushed from the front of the connecting base body 10 to mate the lock block 211 with the lock slot 14 to mount the waterproof shell 20 covering out of the connecting base body 10. Next, the waterproof device 30 is mated to the bottom of the waterproof shell 20, and the transmission wire 40 is passed between the waterproof device 30 and the inside of the waterproof shell 20.

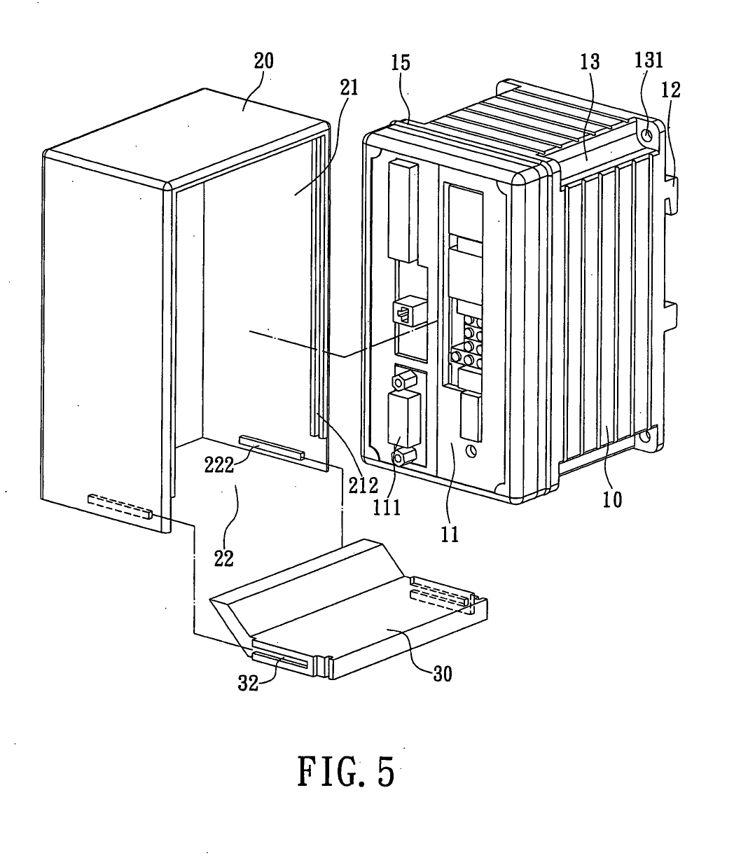

Referring to FIG. 5, which is a second embodiment of the present invention, the waterproof shell 20 has a lock slot 212 on the inside wall of the hatch 21. A lock block 15 is set on the outside of the connecting base body 10 near the connecting port board 11. The lock block 15 is mated into the lock slot 212 to mount the waterproof shell 20 covering out of the connecting base body 10 and the connecting ports 111. Two integrating flanges 222 are set on two opposite inside walls of the waterproof shell 20 at the integrating hatch 22 respectively. The waterproof device 30 has two integrating slots 32 on two opposite sidewalls respectively. The two integrating flanges 222 are mated into the two integrating slots 32 respectively to mount the waterproof device 30 onto the waterproof shell 20.

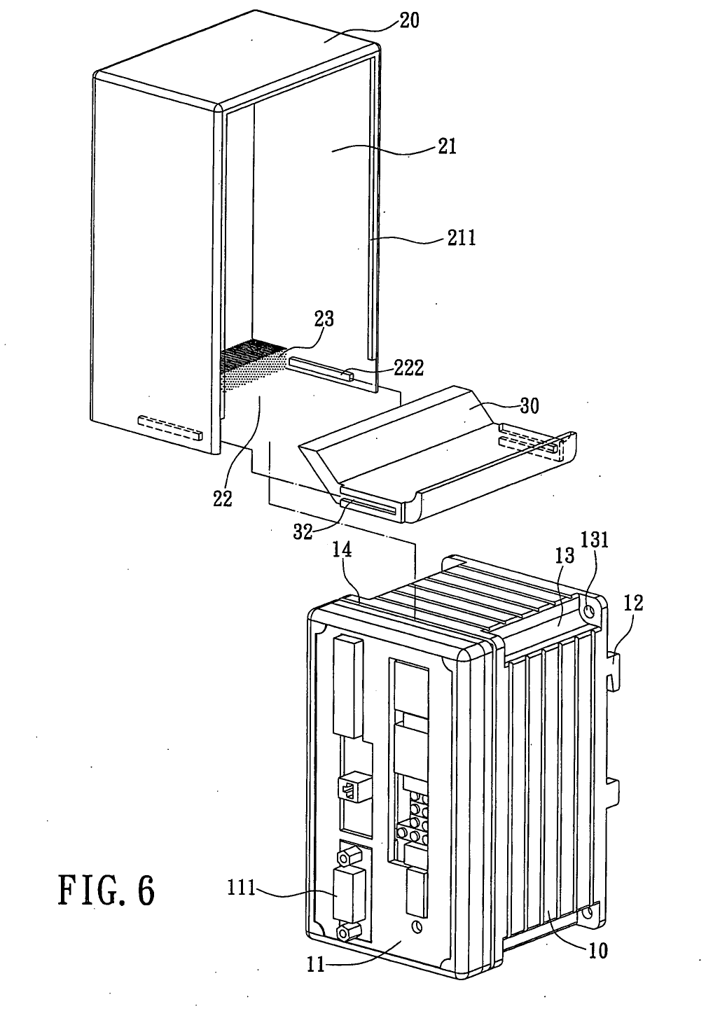

Referring to FIG. 6, which is a third embodiment of the present invention, a flexible waterproof component 23 is set between the waterproof device 30 and the waterproof shell 20. The flexible waterproof component 23 can be a set of hair brush, and the hair of the brush can be disposed in a single direction, or in two opposite directions. The transmission wire 40 passes through the flexible waterproof component 23 to connect with the connecting ports 111 of the connecting base body 10, thereby, the waterproof function of the waterproof shell 20 is improved upon by the flexible waterproof component 23. Moreover, the material of the flexible waterproof component 23 can be foam or other flexible waterproof materials.

The waterproof shell 20 of the present invention can cover all of the connecting ports 111. It is unnecessary to design a new waterproof loop for the different types of the connecting ports 111, which reduces purchasing costs or avoid the necessity of purchasing costly accessories, thereby reducing costs to a user. Furthermore, the waterproof shell 20 is not affected by the number of connecting ports 111 connected to the connecting base body 10, so maintenance and assembly are more advantageous.

What is disclosed above are only the preferred embodiments of the present invention, and therefore it is intended that the present invention not be limited to the particular embodiment disclosed. It should be understood by those skilled in the art that various equivalent changes may be made depending on the specification and the drawings of present invention without departing from the scope of the present invention.

What is claimed is:

1. An all-in-one connecting base having a waterproof device, comprising:
a connecting base body, having at least one connecting port thereon;
a waterproof shell mounted outside of the connecting base body and covering the at least one connecting port, and
a waterproof device set movably on the waterproof shell.

2. The all-in-one connecting base having a waterproof device as claimed in claim 1, wherein a connecting port board is set on the connecting base body and the connecting ports are set on the connecting port board.

3. The all-in-one connecting base having a waterproof device as claimed in claim 1, wherein a flexible waterproof component is set between the waterproof device and the waterproof shell.

4. The all-in-one connecting base having a waterproof device as claimed in claim 3, wherein the flexible waterproof component is made of a set of hair brush or foam.

5. The all-in-one connecting base having a waterproof device as claimed in claim 1, wherein the connecting port can be a power connecting port, a voice connecting port, a display screen connecting port, a serial connecting port, or a network connecting port.

6. The all-in-one connecting base having a waterproof device as claimed in claim 1, wherein the waterproof shell has a hatch on a sidewall thereof to cover the connecting base body.

7. The all-in-one connecting base having a waterproof device as claimed in claim 6, wherein the waterproof shell has a lock slot on the inside wall at the hatch, a lock block is set on the outside of the connecting base body to mate with the lock slot.

8. The all-in-one connecting base having a waterproof device as claimed in claim 6, wherein a lock block is disposed on the inside wall of the waterproof shell at the hatch, the connecting base has a lock slot on the outside thereof to mate with the lock block.

9. The all-in-one connecting base having a waterproof device as claimed in claim 1, wherein the waterproof shell has an integrating hatch on the sidewall thereof and the waterproof device is received in the integrating hatch.

10. The all-in-one connecting base having a waterproof device as claimed in claim 9, wherein the waterproof shell has two integrating slots on two opposite sides inside the integrating hatch, two integrating flanges are set on two opposite outside walls of the waterproof device to mate with the two integrating slots respectively.

11. The all-in-one connecting base having a waterproof device as claimed in claim 9, wherein two integrating flanges are set on two opposite sides inside the waterproof shell at the integrating hatch, the waterproof device has two integrating slots on two opposite outside walls to mate with the two integrating flanges respectively.
